(19) United States
(12) Patent Application Publication
(10) Pub. No.: US 2015/0154822 A1
(43) Pub. Date: Jun. 4, 2015

(54) Security Device for a Lottery Ticket Machine

(71) Applicants: Chi-Ming Tsai, Hemei Town (TW); I-Chiang Yang, Hemei Town (TW)

(72) Inventors: Chi-Ming Tsai, Hemei Town (TW); I-Chiang Yang, Hemei Town (TW)

(21) Appl. No.: 14/093,598

(22) Filed: Dec. 2, 2013

(51) Int. Cl. G07F 11/00; G07F 17/42; B65D 83/08

(52) U.S. Cl. CPC G07F 11/005; B65D 83/0829; G07F 17/42

(57) ABSTRACT

A lottery ticket machine including a chute for guiding a series of lottery tickets, two rollers for conveying the series of lottery tickets, a handle operable for moving the rollers from each other, and a security unit movable between a locking position for avoiding movement of the rollers from each other and a releasing position for allowing the rollers to move from each other. The handle is operable to move the security unit between the locking position and the releasing position.

### BACKGROUND OF INVENTION

1. Field of Invention

The present invention relates to a and, more particularly, to a

2. Related Prior Art

Referring to FIG. 4, a conventional lottery ticket machine is shown. The lottery ticket machine includes a panel 900, two plates 902, a chute 904, two lower rollers 906, two upper rollers 908, two rockers 910, two springs 914 and a handle 916. The panel 900 includes a slot 914. Each of the plates 902 includes an arched slot 912. The plates 902 are connected to the panel 900 so that the plates 902 extend parallel to each other. The chute 904 is placed between the plates 902. The chute 904 is made of two separate strips (not numbered). The lower rollers 906 are placed between and connected to the plates 902. Furthermore, the lower rollers 906 are operably connected to a motor (not numbered). The upper rollers 908 are placed on a first shaft (not numbered) that extends through the arched slots 912. The rockers 910 are connected to a second shaft (not numbered) that rests on the plates 902. Each of the rockers 910 includes an end connected to the first shaft and another end connected to the second shaft. Each of the springs 914 includes an end tied to a corresponding one of the plates 902 and another end tied to the first shaft. The handle 916 is connected to the second shaft so that the handle 916, the rockers 910 and the upper rollers 908 rock together as the first shaft moves along the arched slots 912. Referring to FIG. 6, in operation, the handle 916 is pivoted upward to lift the upper rollers 908 from the lower rollers 906 before a series of lottery tickets is placed between the upper rollers 908 and the lower rollers 906 through the chute 904. Referring to FIG. 5, the handle 916 is released to allow the springs 914 to move the upper rollers 908 closer to the lower rollers 906 before the motor is turned on to drive the lower rollers 906 to convey the series of lottery tickets along the chute 904 and finally out of the lottery ticket machine through the slot 918. The motor is stopped after at least one lottery ticket (the “desired lottery ticket”) is placed out of the lottery ticket machine. Then, the desired lottery ticket is pulled from the lottery ticket machine, and so is a next lottery ticket. The next lottery ticket brings the upper rollers 908 closer to the lower rollers 906 while the first shaft moves along the arched slots 912. Thus, the next lottery ticket is nipped by the lower rollers 906 and the upper rollers 908. The desired lottery ticket is further pulled from the lottery ticket machine and finally torn from the next lottery ticket. However, a person can steal the whole series of lottery tickets from the lottery ticket machine if he or she inserts a tool into the lottery ticket machine through the slot 918 to push and lift the upper rollers 908 from the lower rollers 906. Therefore, the lottery ticket machine is not secure.

The present invention is therefore intended to obviate or at least alleviate the problems encountered in the prior art.

### SUMMARY OF INVENTION

It is the primary objective of the present invention to provide a secure lottery ticket machine.

To achieve the foregoing objective, the lottery ticket machine including a chute for guiding a series of lottery tickets, two rollers for conveying the series of lottery tickets, a handle operable for moving the rollers from each other, and a security unit movable between a locking position for avoiding movement of the rollers from each other and a releasing position for allowing the rollers to move from each other. The handle is operable to move the security unit between the locking position and the releasing position.

Other objectives, advantages and features of the present invention will be apparent from the following description referring to the attached drawings.

### BRIEF DESCRIPTION OF DRAWINGS

The present invention will be described via detailed illustration of the preferred embodiment versus a conventional lottery ticket machine referring to the drawings wherein:

FIG. 1 is a perspective view of a secure lottery ticket machine according to the preferred embodiment of the present invention;

FIG. 2 is a side view of the secure lottery ticket machine shown in FIG. 1;

FIG. 3 is a side view of the secure lottery ticket machine in another position than shown in FIG. 2;

FIG. 4 is a perspective view of a conventional lottery ticket machine;

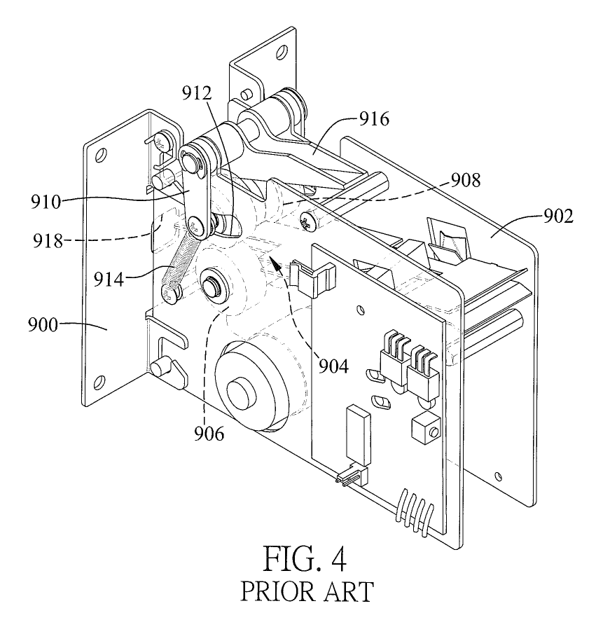

FIG. 5 is a side view of the conventional lottery ticket machine shown in FIG. 4; and

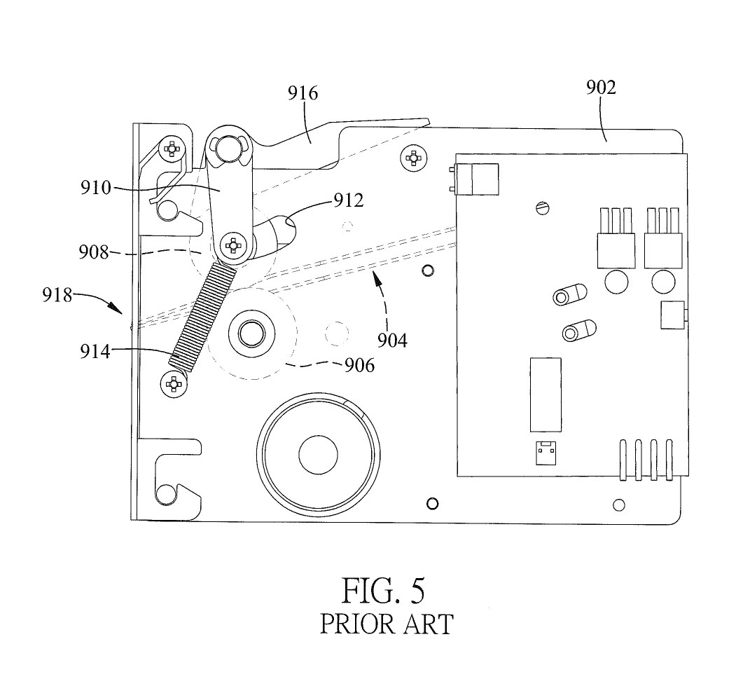

FIG. 6 is a side view of the conventional lottery ticket machine in another position than shown in FIG. 5.

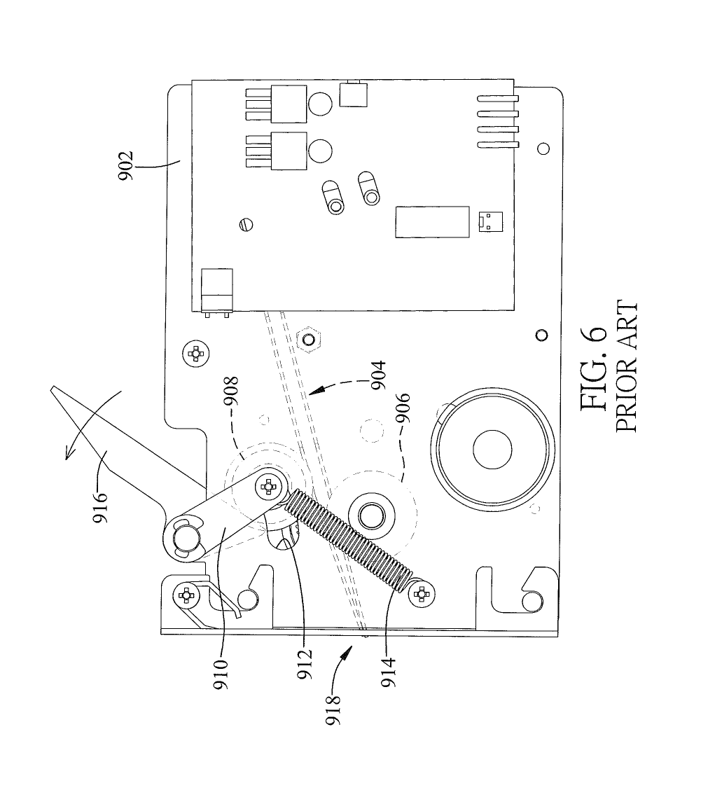

### DETAILED DESCRIPTION OF PREFERRED EMBODIMENT

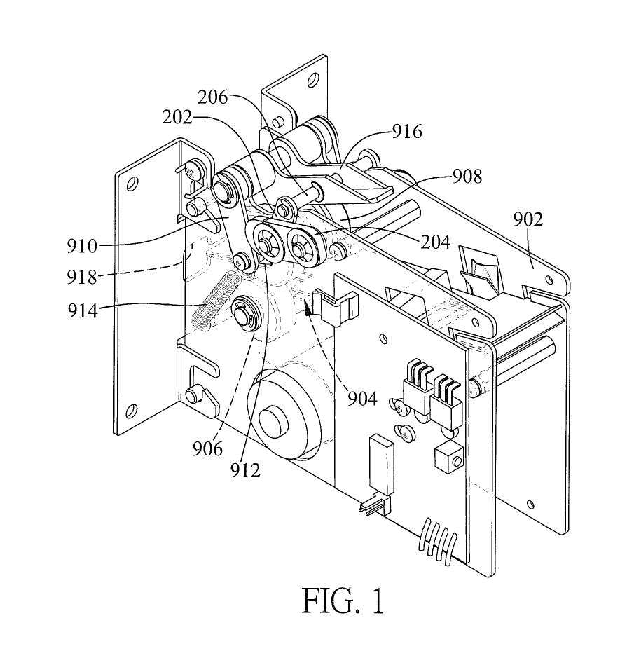

Referring to FIG. 1, there is a secure lottery ticket machine according to the preferred embodiment of the present invention. The secure lottery ticket machine includes a panel 900, two plates 902, a chute 904, two lower rollers 906, two upper rollers 908, two rockers 910, two springs 914, a handle 916 and a security unit 200.

The panel 900 includes a slot 914. Each of the plates 902 includes an arched slot 912. The plates 902 are connected to the panel 900 so that the plates 902 extend parallel to each other. The chute 904 is placed between the plates 902. The chute 904 is made of two separate strips (not numbered).

The lower rollers 906 are placed between and connected to the plates 902. Furthermore, the lower rollers 906 are operably connected to a motor (not numbered).

The upper rollers 908 are placed between the plates 902. In addition, the upper rollers 908 are supported on a first shaft (not numbered) that extends through the arched slots 912.

The rockers 910 are connected to a second shaft (not numbered) that is supported on the plates 902. Each of the rockers 910 includes an end connected to the first shaft and another end connected to the second shaft.

Each of the springs 914 includes an end tied to a corresponding one of the plates 902 and another end tied to the first shaft. The handle 916 is connected to the second shaft so that the handle 916, the rockers 910 and the upper rollers 908 rock together as the first shaft moves along the arched slots 912.

The security unit 200 includes two levers 202, two stoppers 204 and a shaft 206. The shaft 206 is connected to handle 916. Each of the levers 202 includes an end pivotally connected to the shaft 206. Each of the stoppers 204 includes an end pivotally connected to a corresponding one of the plates 902. Another end of each of the levers 202 is connected to a corresponding one of the stoppers 204.

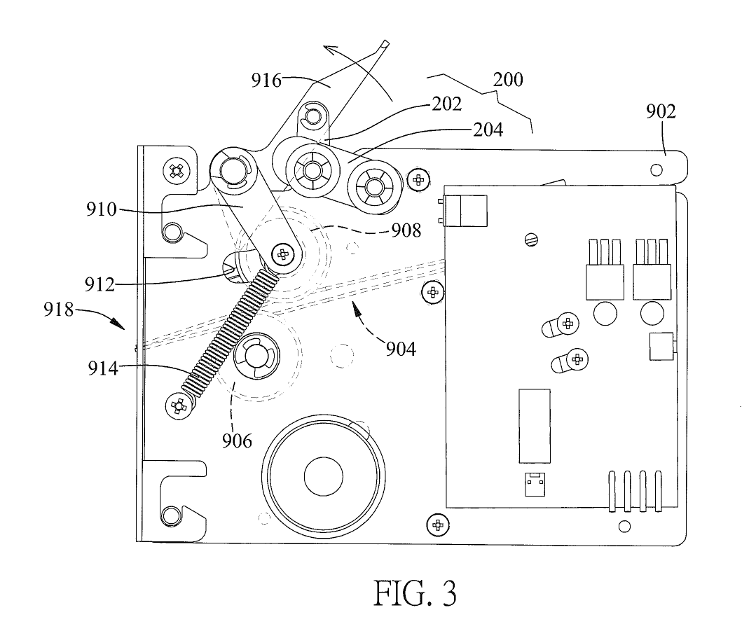

Referring to FIG. 3, in operation, the handle 916 is pivoted upward. The handle 916 lifts the levers 202. The levers 202 lift the stoppers 204 from the rockers 910 to allow the handle 916 to pivot the rockers 910. The rockers 910 lift the upper rollers 908 from the lower rollers 906. Then, a series of lottery tickets is placed between the upper rollers 908 and the lower rollers 906 through the chute 904.

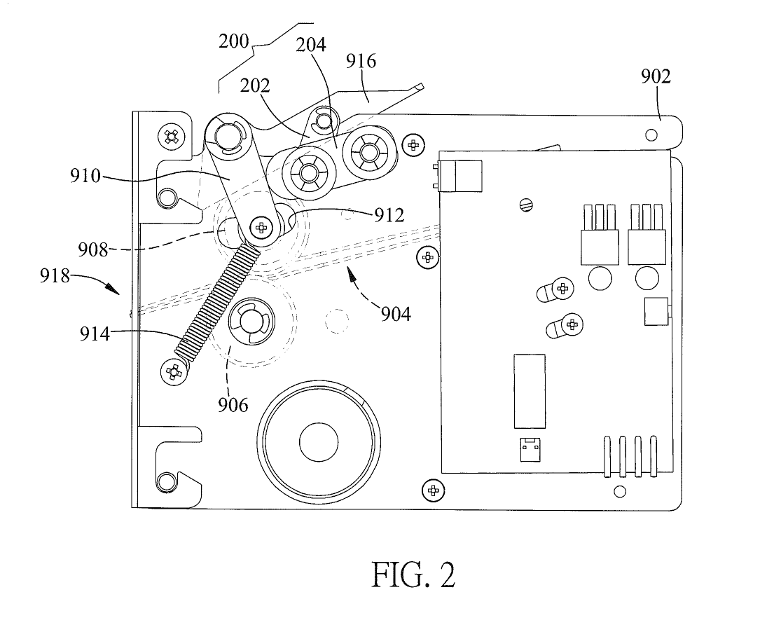

Referring to FIG. 2, the handle 916 is released. Thus, the springs 914 are allowed to move the upper rollers 908 closer to the lower rollers 906. Then, the motor is turned on to drive the lower rollers 906 to convey the series of lottery tickets along the chute 904 and finally out of the lottery ticket machine through the slot 918.

The motor is stopped after at least one lottery ticket (the “desired lottery ticket”) is placed out of the lottery ticket machine. Then, the desired lottery ticket is subjected to a force that tends to pull from the series of lottery tickets from the lottery ticket machine. A next lottery ticket however brings the upper rollers 908 closer to the lower rollers 906. Thus, the next lottery ticket is nipped by the lower rollers 906 and the upper rollers 908. If the force is sufficient, the desired lottery ticket will be torn from the next lottery ticket, which is kept in the lottery ticket machine.

A person might insert a tool into the lottery ticket machine via the slot 918. However, the person cannot push and lift the upper rollers 908 from the lower rollers 906 because the stoppers 204 stop the rockers 910 from pivoting. The stoppers 204 effectively stop the rockers 910 from pivoting because the stoppers 204 extend substantially perpendicular to the rockers 910 and because the stoppers 204 are not rectilinearly movable substantially perpendicular to the rockers 910. Thus, the person cannot steal any lottery ticket from the lottery ticket machine because, and the lottery ticket machine is secure.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A lottery ticket machine including a chute 904 for guiding a series of lottery tickets, first and second rollers 906/908 for conveying the series of lottery tickets, a handle 916 operable for moving the first and second rollers 906/908 from each other, and a security unit 200 movable between a locking position for avoiding movement of the first and second rollers 906/908 from each other and a releasing position for allowing the first and second rollers 906/908 to move from each other, wherein the handle 916 is operable to move the security unit 200 between the locking position and the releasing position.

2. The lottery ticket machine according to claim 1, wherein the first roller 906 is adapted for rotation about a stationary axis.

3. The lottery ticket machine according to claim 2, wherein the second roller 908 is adapted for rotation about a movable axis.

4. The lottery ticket machine according to claim 3, wherein the movable axis is movable in an arched path.

5. The lottery ticket machine according to claim 4, including a rocker 910 with an end connected to the handle 916 so that they are pivotable together and another end connected to the second roller 908.

6. The lottery ticket machine according to claim 5, including a spring 914 for biasing the rocker 910.

7. The lottery ticket machine according to claim 5, wherein the security unit 200 includes a stopper 204 adapted for stopping the rocker 910.

8. The lottery ticket machine according to claim 7, wherein the stopper 204 is pivotable.

9. The lottery ticket machine according to claim 8, wherein the stopper 204 normally extends perpendicular to the rocker 910.

10. The lottery ticket machine according to claim 9, wherein the security unit 200 includes a lever 202 for connecting the stopper 204 to the handle 916.

11. The lottery ticket machine according to claim 10, wherein the security unit 200 includes a shaft 206 for pivotally connecting the lever 202 to the handle 916.

12. The lottery ticket machine according to claim 8, including a plate 902 for supporting the chute 904, the first roller 906, the rocker 910, the spring 914 and the handle 916.
